(19) United States
(12) Patent Application Publication
(10) Pub. No.: US 2025/0374148 A1
(43) Pub. Date: Dec. 4, 2025

(54) PROACTIVE EXTERNAL WIRELESS INTERFERENCE MITIGATION

(71) Applicant: Dell Products L.P., Round Rock, TX (US)

(72) Inventors: Medhat Khalifa, Giza (EG); Marwan Mansour, Alexandria (EG); Abdulrahman Darwish, Cairo (EG); Mohamed Abouzeid, El Sheikh Zayed (EG)

(21) Appl. No.: 18/677,488

(22) Filed: May 29, 2024

(51) Int. Cl. H04W 36/30; H04W 36/00

(52) U.S. Cl. CPC H04W 36/30; H04W 36/0072

(57) ABSTRACT

Proactive external wireless interference mitigation is presented herein. Based on first metrics corresponding to a group of wireless devices that has been communicatively coupled to a wireless access point device, a system partitions a wireless coverage area into respective regions. Based on second metrics representing external interference corresponding to respective physical resource blocks utilized via wireless communications corresponding to the respective regions, the system associates defined degrees of the external interference to the respective regions. In response to determining that a location of a wireless device corresponds to a region of the respective regions, the system determines whether a defined degree of the external interference associated with the region satisfies a defined condition representing that portion(s) of wireless resources corresponding to the region are to be prevented from being assigned to the wireless device to minimize an effect of the external interference on the wireless device.

### TECHNICAL FIELD

The subject disclosure generally relates to embodiments for proactive external wireless interference mitigation.

### BACKGROUND

External wireless interference is caused by source(s) outside of a control of a wireless network infrastructure, and affects a frequency band or sub-band including a range of frequencies that have been assigned to application(s) of the wireless network. An entire cell, or geographical area covered by one or more frequencies emitted by a base station within a cellular network, can be affected by external wireless interference, or only specific portion(s)/area(s) of the cell can be affected by such interference, which can increase latency, handover failure, block error rate (BLER), and/or call drop, e.g., based on a reduction of wireless signal quality within the cell and/or portion(s)/area(s) of the cell.

### BRIEF DESCRIPTION OF THE DRAWINGS

Non-limiting embodiments of the subject disclosure are described with reference to the following Figures, in which like reference numerals refer to like parts throughout the various views unless otherwise specified:

FIG. 1 illustrates a block diagram of a wireless communication environment including a proactive external wireless interference mitigation system to facilitate proactive external wireless interference mitigation by preventing at least a portion of wireless resources corresponding to a region of a wireless coverage area of a wireless access point device from being assigned to a wireless device, in accordance with various example embodiments;

FIG. 2 illustrates a block diagram of a proactive external wireless interference mitigation system, in accordance with various example embodiments;

FIG. 3 illustrates a block diagram of a wireless coverage area of a wireless access point device that has been divided into a group of areas, in accordance with various example embodiments;

FIG. 4 illustrates a block diagram of a wireless coverage area of a wireless access point device that has been divided into a group of areas in which degrees of external interference that have been determined to have impacted respective areas of the group of areas have been assigned to the respective areas, in accordance with various example embodiments;

FIG. 5 illustrates a block diagram of a wireless coverage area of a wireless access point device that has been divided into a group of areas in which at least a portion of wireless resources corresponding to an area of the group of areas is to be prevented from being assigned to a wireless device, in accordance with various example embodiments.

FIGS. 6-7 illustrate flow charts of a method associated with a proactive external wireless interference mitigation system, in accordance with various example embodiments;

FIGS. 8-9 illustrate flow charts of another method associated with a proactive external wireless interference mitigation system, in accordance with various example embodiments; and

FIG. 10 illustrates a block diagram representing an illustrative non-limiting computing system or operating environment in which one or more aspects of various embodiments described herein can be implemented.

### DETAILED DESCRIPTION

Aspects of the subject disclosure will now be described more fully hereinafter with reference to the accompanying drawings in which example embodiments are shown. In the following description, for purposes of explanation, numerous specific details are set forth in order to provide a thorough understanding of the various embodiments. However, the subject disclosure may be embodied in many different forms and should not be construed as limited to the example embodiments set forth herein.

As described above, external wireless interference can negatively affect performance of a wireless communication within a wireless network by increasing latency, handover failure, BLER, and/or call drop, e.g., based on a reduction of wireless signal quality within a coverage area of a cell lowering a quality of a wireless service corresponding to the wireless communication.

Conventional wireless technologies address external wireless interference reactively-after such interference has already affected a wireless communication, e.g., by subsequently removing portions of the wireless network (e.g., physical resource blocks (PRBs) corresponding to the wireless communication that have been determined to have been affected by the external interference; by assigning lower priorities to frequency bands corresponding to the wireless communication that have been determined to have been affected by the external interference.

Such reactive nature of conventional wireless technologies in attempting to correct for external wireless interference causes a delay in addressing the external interference-allowing for reduced wireless subscriber experiences, e.g., poor call quality, dropped calls, and/or poor data transmission during such delay.

Further, conventional wireless technologies attempt to correct for external interference across an entire geographical area and/or all areas/regions of a cell, without considering whether only specific areas/regions within the cell are experiencing the external interference-resulting in inefficient use of wireless resources as portion(s) of the cell that are not affected by the external interference are under-utilized due to correction of the external wireless interference being applied across all areas/regions of the cell.

In various embodiments described herein, a proactive external wireless interference mitigation system can facilitate proactive external wireless interference mitigation by preventing at least a portion of wireless resources corresponding to a region of a wireless coverage area of a wireless access point device from being assigned to a user equipment (UE), e.g., by proactively preventing PRBs from being scheduled to be utilized by the UE within the region; by proactively initiating a handover of a wireless communication corresponding to the UE to a neighboring wireless access point device of the wireless access point device; or by proactively initiating an idle mode redirection associated with an establishment of a packet data unit (PDU) session of the UE corresponding to the neighboring wireless access point device.

For example, in embodiment(s), a system, e.g., a proactive external wireless interference mitigation system, comprises a processor and a memory that stores executable components that, when executed by the processor, facilitate performance of operations by the system, the operations comprising: based on first wireless device metrics corresponding to a group of wireless devices (e.g., comprising a wireless device, a combination wired and wireless device, a UE, or any device that comprises wireless capabilities with respect to embodiments described herein) that has been communicatively coupled to a wireless access point device, partitioning a wireless coverage area of the wireless access point device into respective regions; based on second wireless device metrics representing external interference corresponding to respective PRBs that have been utilized via wireless communications corresponding to the respective regions, associating defined degrees of the external interference to the respective regions; and in response to determining that a location of a wireless device corresponds to a region of the respective regions, determining whether a defined degree of the defined degrees of the external interference that has been associated with the region satisfies a defined condition, wherein the defined condition represents that at least a portion of wireless resources corresponding to the region are to be prevented from being assigned to the wireless device to minimize an effect of the external interference on the wireless device.

In embodiment(s), the first wireless device metrics comprise respective reference signal receive powers (RSRPs) corresponding to the group of wireless devices and respective distributions and/or locations of the wireless devices within the wireless coverage area.

In other embodiment(s), the group of wireless devices is a first group of wireless devices, the second wireless device metrics comprise respective received signal strength indicators (RSSIs) corresponding to a second group of wireless devices, and the second device metrics further represent locations of respective wireless devices of the second group of wireless devices within the wireless coverage area.

In yet other embodiment(s), the portion of wireless resources is a first portion of wireless resources, and the associating of the defined degrees of the external interference to the respective regions comprises: determining, for PRBs of the respective PRBs corresponding to a second portion of the wireless communications corresponding to the region, a percentage of the PRBs that has been affected by respective portions of the external interference; and based on the percentage of the PRBs that has been determined to have been affected by the respective portions of the external interference, assigning a defined degree of the defined degrees of the external interference to the region.

In embodiment(s), the determining of the percentage of the PRBs that has been affected by the respective portions of the external interference comprises: determining a received signal strength indicator (RSSI) corresponding to a physical resource block (PRB) of the PRBs; and in response to the RSSI being determined to be greater than a defined maximum RSSI value, determining that the PRB has been affected by one or more portions of the respective portions of the external interference.

In other embodiment(s), the operations further comprise: in response to the defined degree of the external interference being determined to satisfy the defined condition representing that at least the first portion of wireless resources corresponding to the region is to be prevented from being assigned to the wireless device, preventing, based on the defined degree of the external interference, at least the first portion of wireless resources from being assigned to the wireless device to mitigate or minimize the effect of the external interference on the wireless device.

In yet other embodiment(s), the preventing comprises: in response to the defined degree of the external interference being determined to represent that a group of PRBs of the respective PRBs corresponding to the region are to be banned from being scheduled to be utilized by the wireless device within the region, preventing, e.g., via notching, the group of PRBs from being scheduled to be utilized by the wireless device within the region.

In embodiment(s), the group of wireless devices is a first group of wireless devices, a second group of wireless devices comprises the wireless device, and the preventing comprises: in response to the defined degree of the external interference being determined to represent that at least one of respective handovers corresponding to wireless devices of the second group of wireless devices or respective idle mode redirections corresponding to the wireless devices are to be performed, initiating at least one of the respective handovers or the respective idle mode redirections.

In other embodiment(s), the defined condition is a first defined condition and the initiating of the respective handovers comprises: determining, for each wireless device of the second group of wireless devices, respective neighboring wireless access point devices corresponding to the access point device; determining respective degrees of external interference corresponding to the respective neighboring wireless access point devices; and in response to a degree of the respective degrees of external interference corresponding to a neighboring wireless access point device of the neighboring wireless access point devices being determined to satisfy a second defined condition representing that the neighboring wireless access point device is an acceptable handover candidate, initiating a handover of the respective handovers of a wireless communication corresponding to the wireless access point device from the wireless access point device to the neighboring wireless access point device.

In yet other embodiment(s), the defined condition is a first defined condition, the group of wireless devices is a first group of wireless devices, a second group of wireless devices comprises the wireless device, and the initiating of the respective idle mode redirections comprises: determining, for each wireless device of the second group of wireless devices, respective neighboring wireless access point devices corresponding to the access point device; determining respective degrees of external interference corresponding to the respective neighboring wireless access point devices; and in response to a degree of external interference of the respective degrees of external interference corresponding to a neighboring wireless access point device of the neighboring wireless access point devices being determined to satisfy a second defined condition representing that the neighboring wireless access point device is an acceptable idle mode redirection candidate, initiating, for the wireless device, an idle mode redirection associated with establishment of a PDU session corresponding to the neighboring wireless access point device.

In embodiment(s), a method comprises: based on first information corresponding to a group of user devices that has been communicatively coupled to a network access point device, dividing, by a system comprising at least one processor, a coverage area of the network access point device into a group of cells; based on second information representing external interference corresponding to respective PRBs that have been utilized via network communications corresponding to the group of cells, assigning, by the system, defined ranks of the external interference to the cells, wherein the external interference represents interference that has been determined to have been caused by at least one source of noise that is outside of a control of the system; determining, by the system, whether a location of a user device corresponds to a cell of the group of cells; and in response to the location of the user device being determined to correspond to the cell, determining, by the system, whether a defined rank of the defined ranks of the external interference that has been assigned to the cell satisfies a defined condition indicating that at least a portion of network resources corresponding to the cell are to be prevented from being assigned to the user device

In other embodiment(s), the dividing of the coverage area into the group of cells comprises: dividing, via a density-based spatial clustering of applications with noise (DBSCAN) algorithm, the coverage area into the group of cells.

In yet other embodiment(s), the assigning of the defined ranks of the external interference to the cells comprises: based on the second group of defined performance indicators, assigning a rank of a group of three ranks to respective cells of the group of cells.

In embodiment(s), the method further comprises in response to the defined rank of the external interference that has been assigned to the cell being determined to satisfy the defined condition indicating that at least the portion of network resources corresponding to the cell are to be prevented from being assigned to the user device, preventing, by the system, at least the portion of network resources from being assigned to the user device.

In other embodiment(s), the preventing comprises: in response to the defined rank of the external interference being determined to represent that a group of PRBs of the respective PRBs corresponding to the cell are to be banned from being scheduled to be utilized by the user device within the cell, preventing the group of PRBs from being scheduled to be utilized by the user device within the cell; and in response to the defined rank of the external interference being determined to represent that at least one of respective handovers corresponding to user devices or respective idle mode redirections corresponding to the user devices are to be performed, initiating at least one of the respective handovers or the respective idle mode redirections.

In yet other embodiment(s), the assigning of the defined ranks of the external interference comprises: determining, by the system, a percentage of PRBs of the respective PRBs of the cell that has been affected by respective portions of the external interference; and based on the percentage of PRBs that has been determined to have been affected by the respective portions of the external interference, assigning, by the system, a defined rank of the defined ranks of the external interference to the cell.

In embodiment(s), the determining of the percentage of PRBs that has been affected by the respective portions of the external interference comprises: in response to an RSSI corresponding to a PRB of the PRBs being determined to be greater than a defined RSSI threshold value, determining, by the system, that the PRB has been affected by one or more portions of the respective portions of the external interference.

In other embodiment(s), the determining of the PRBs that has been affected by the respective portions of the external interference comprises: obtaining, via a data store, historical interference data representing percentages of the respective PRBs of the cell that have been affected by the respective portions of the external interference over respective defined periods; and based on the historical inference data, determining the percentage of PRBs of the respective PRBs of the cell that has been affected by respective portions of the external interference.

In yet other embodiment(s), a non-transitory machine-readable medium comprises executable instructions that, when executed by a processor, facilitate performance of operations, comprising: based on first UE metrics corresponding to a group of UE that has been communicatively coupled to access point equipment within a coverage area of the access point equipment, dividing the coverage area into cells; based on second UE metrics representing external interference corresponding to respective PRBs that have been utilized via cellular communications corresponding to the cells, assigning a defined rank of external interference of a group of defined ranks of the external interference to the cells, wherein the external interference represents interference that has been determined to have been caused by at least one source of noise that has not been generated by the system; and in response to a location of a UE being determined to correspond to a cell of the cells, determining whether a defined rank of the defined ranks of the external interference that has been assigned to the cell satisfies a defined condition representing that at least a portion of network resources corresponding to the cell is to be prevented from being assigned to the UE to mitigate or minimize an effect of the external interference on the UE.

In embodiment(s), the operations further comprise: in response to the defined rank being determined to satisfy the defined condition representing that at least the portion of network resources corresponding to the cell is to be prevented from being assigned to the UE, preventing a group of PRBs of the respective PRBs from being scheduled to be utilized by the UE within the cell, initiating a handover of a cellular communication of the cellular communications corresponding to the UE to neighboring access point equipment neighboring the access point equipment, or initiating an idle mode redirection associated with establishment of a PDU session of the UE corresponding to the neighboring access point equipment.

As described above, conventional wireless technologies attempt to correct for interference after such interference has already occurred and a user's experience has been negatively affected, e.g., via poor call quality, dropped calls, poor data transmission, and similar reduced communication performance. Further, such technologies attempt to correct for interference across an entire geographical area and across all areas/regions of a cell—resulting in under-utilization of areas/regions of the cell that have been unaffected by the interference.

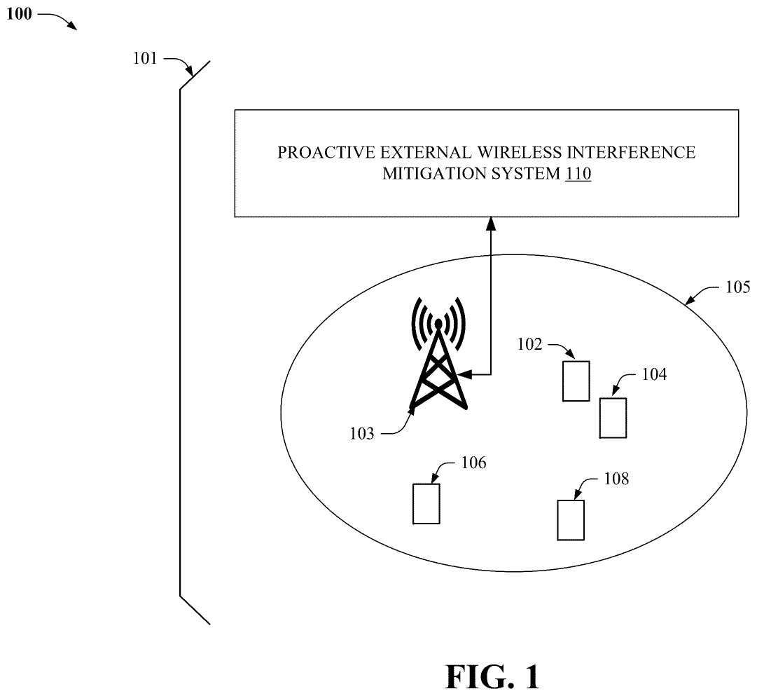

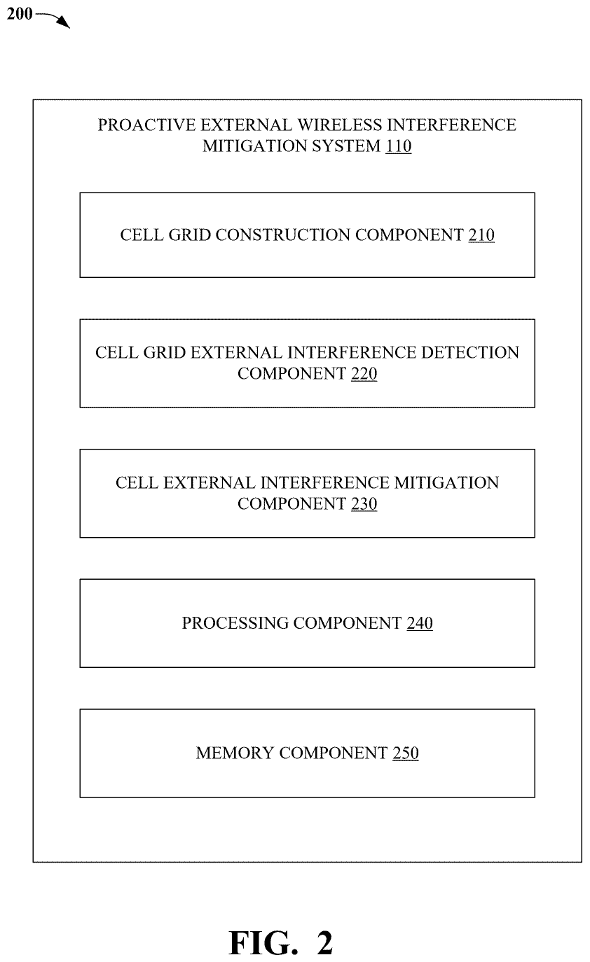

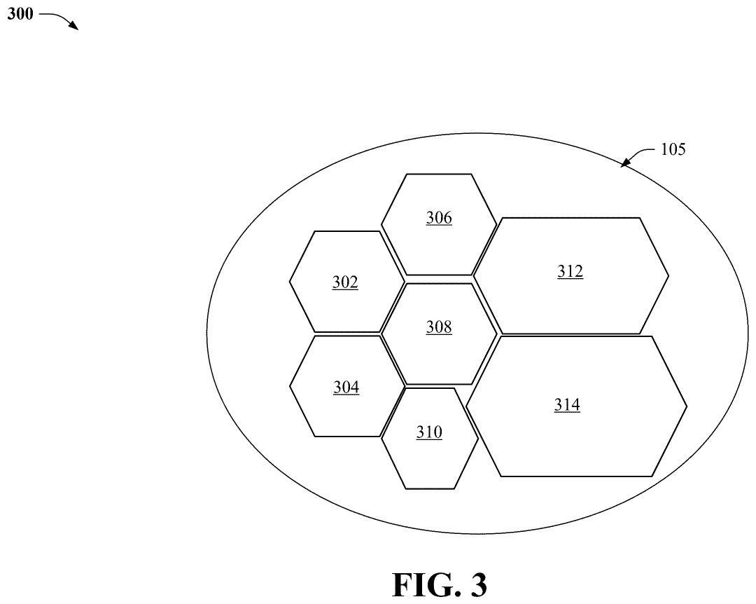

In various embodiments described herein, and now referring to FIGS. 1-3, a proactive external wireless interference mitigation system (110) of a wireless communication environment (101) can facilitate proactive external wireless interference mitigation by proactively preventing, before a user's communication experience is negatively affected by such interference, portion(s) of wireless resources corresponding to a region of a wireless coverage area (105) of a wireless access point device (103) from being assigned to a UE (102, 104, 106, 108), e.g., preventing PRBs from being scheduled to be utilized by the UE within the region; initiating a handover of a wireless communication corresponding to the UE to a neighboring wireless access point device of the wireless access point device; or initiating an idle mode redirection associated with an establishment of a PDU session of the UE corresponding to the neighboring wireless access point device.

The proactive external wireless interference mitigation system includes a cell grid construction component (210), a cell grid external interference detection component (220), a cell external interference mitigation component (230), a processing component (240), and a memory component (250). In embodiment(s), the memory component stores executable instructions that, when executed by the processing component, facilitate performance of operations by the proactive external wireless interference mitigation system, e.g., via the cell grid construction component, the cell grid external interference detection component, and the cell external interference mitigation component.

In this regard, in embodiment(s), the cell grid construction component obtains wireless device metrics, e.g., non-real-time-based metrics, corresponding to a group of user equipment (e.g., wireless devices, wired and wireless devices) (e.g., 102, 104, 106, 108) that has been communicatively coupled to a wireless access point device (103). The wireless device metrics comprise respective RSRPs corresponding to the group of user equipment and respective distributions and/or locations of the user equipment within the wireless coverage area.

In an embodiment, the cell grid construction component obtains the RSRPs and locations of the group of user equipment via one or more interfaces (e.g., A1, O1, O2, E2, R1) of a service management and orchestration (SMO) layer of an open radio access network (O-RAN) based architecture, e.g., corresponding to the wireless access point device and/or the group of user equipment.

In turn, based on the non-real-time-based metrics, the cell grid construction component divides and/or partitions the wireless coverage area into a group of cells and/or regions (302, 304, 306, 308, 310, 312, 314).

In one embodiment, the cell grid construction component divides and/or partitions the wireless coverage area into the group of cells and/or regions utilizing a density-based spatial clustering of applications with noise (DBSCAN) algorithm.

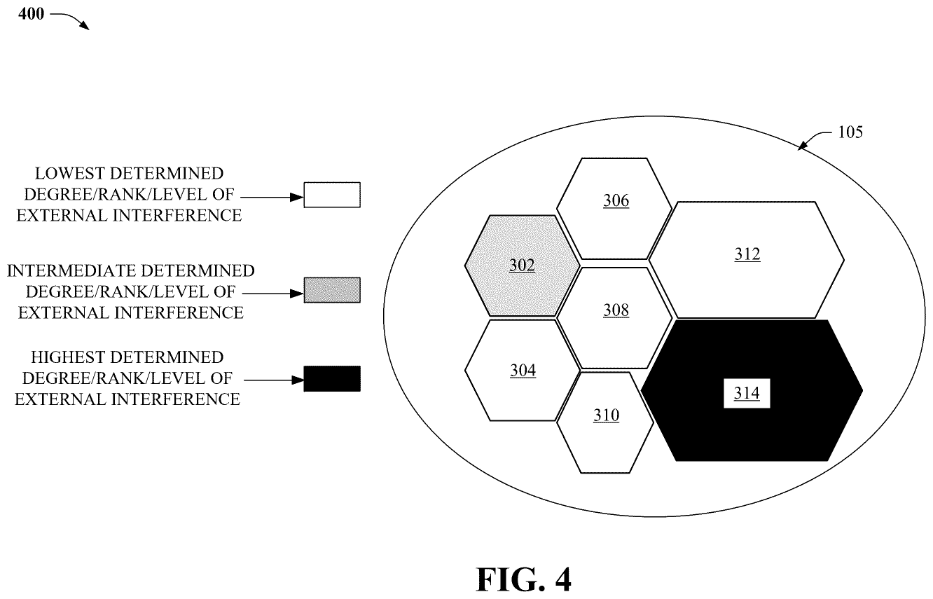

Referring now to FIG. 4, the cell grid external interference detection component obtains wireless device metrics, e.g., near real-time-based metrics, representing external interference corresponding to respective PRBs that have been utilized via wireless communications, e.g. via user equipment (e.g., 102, 104, 106, 108, or other user equipment (not shown)) being communicatively coupled to the wireless access point device within the group of cells and/or regions. The near real-time-based metrics comprise respective RSSIs corresponding to the user equipment, and further represent respective locations of the user equipment within the group of cells and/or regions.

In an embodiment, the near real-time-based metrics comprise respective transmission powers of the user equipment and/or respective transmission frequencies of the user equipment.

In embodiment(s), obtains the near real-time metrics, e.g., respective RSSIs and the respective locations of the user equipment via one or more interfaces (e.g., A1, O1, O2, E2, R1) of the SMO, e.g., corresponding to the wireless access point device and/or the user equipment.

In other embodiment(s), the cell grid external interference detection component utilizes an application programming interface (API) to subscribe to and/or monitor E2 nodes of a radio access network (RAN) comprising the wireless access point device to obtain the near real-time metrics, e.g., comprising key performance indicators (KPIs) comprising the respective RSSIs and the respective locations, e.g., in response to the E2 nodes being registered upon respective user equipment being communicatively coupled to the wireless access point device.

In yet other embodiment(s), the cell grid external interface detection component can store and/or update the KPIs via a data store, e.g., of the memory component.

Referring now to FIG. 4, the cell grid external interference detection component predicts and/or determines, based on the KPIs, defined degrees and/or ranks of external interference that have impacted respective cells and/or respective regions of the group of cells and/or regions (e.g., 302, 304, 306, 308, 310, 312, 314)—the external interference representing interference that has been determined to have been caused by source(s) of noise (not shown) that is/are outside of a control of the proactive external wireless interference mitigation system.

Further, the cell grid external interference detection component associates and/or assigns, e.g., via the data store, the predicted and/or determined defined degrees and/or ranks of external interference to the respective cells/regions.

In embodiment(s), the source(s) of noise can be generated by environmental factors (e.g., physical structures), non-Wi-Fi-based devices, electromagnetic interference (EMI), illegal (e.g., non-authorized, non-registered) wireless repeaters, and/or other sources of noise corresponding to the wireless coverage area (105) that have been generated or have occurred unexpectedly.

In various embodiment(s), the cell grid external interference detection component determines, for PRBs corresponding to portion(s) of the wireless communication(s) associated with the respective cells and/or respective regions of the group of cells and/or regions, a percentage of the PRBs that has been affected by respective portions of the external interference.

In embodiment(s), the cell grid external interference detection component determines the percentage of the PRBs that has been affected by the respective portions of the external interference by determining whether an RSSI (e.g., a measured RSSI (RSSI_{measured})) corresponding to a PRB of the PRBs is greater than a defined RSSI threshold value (RSSI_{threshold}).

In turn, in response to the RSSI being determined by the cell grid external interference detection component to be greater than the defined RSSI threshold value, the cell grid external interference detection component determines that the PRB has been affected by one or more portions of the respective portions of the external interference.

For example, in embodiment(s), the cell grid external interference detection component can determine that a PRB has been affected by portion(s) of the external interference, e.g., representing that there is external interference on the PRB, based on the following:

$$Score = {RSSI}_{measured} - {RSSI}_{threshold} ,$$

$$Interference on PRB = \{ \begin{matrix}1 & if score > 0 \\ 0 & otherwise\end{matrix} .$$

In other embodiment(s), the cell grid external interference detection component can utilize the respective RSSIs to assess wideband power, noise, serving cell power, and interference power. In this regard, the cell grid external interference detection component can collect, and store via the data store, RSSI measurements corresponding to respective user equipment over a defined period as portion(s) of the historical data, and determine the defined RSSI threshold value based on the historical data.

In yet other embodiment(s), the cell grid external interference detection component can determine the defined RSSI threshold value based on historical data, e.g., comprising the near real-time-based metrics and the KPIs that have been collected (e.g., via the one or more interfaces (e.g., A1, O1, O2, E2, R1) of the SMO over defined period(s)) and stored, via the cell grid external interference detection component, in the data store.

For example, the cell grid external interference detection component can predict respective expected signal-to-interference-plus-noise ratio (SINR) values representing upper bound/threshold values on respective channel capacities/rate of information transfers corresponding to wireless communication(s) associated with the respective cells and/or respective regions of the group of cells and/or regions.

In embodiment(s), the cell grid external interference detection component, based on the historical data, can employ machine learning, e.g., via a linear regression machine learning model, to predict the respective expected SINR values corresponding to un-interfered user equipment, e.g., based on a linear relationship between a reference signal receive power (RSRP) and SINR of a given user equipment in the absence or external interference.

Further, based on the predicted expected SINR values and the near real-time metrics (e.g., comprising the KPIs comprising the respective RSSIs and the respective locations), the cell grid external interference detection component can predict and/or determine the defined RSSI threshold value.

In turn, based on a percentage of the PRBs of a cell/region of the group of cells/regions that has been determined to have been affected by the respective portions of the external interference, the cell grid external interference detection component determines a defined degree and/or rank of external interference that has impacted the cell/region regions and assigns/associates, e.g., via the data store, the determined defined degree and/or rank to the cell/region.

For example, in embodiment(s), the cell grid external interference detection component can determine the defined degree and/or rank based on the following:

$$defined degree / rank = \{ \begin{matrix}1 st degree / rank & if \% Interfered < x \\ 2 nd degree / rank & if x < \% Interfered < y \\ 3 rd degree / rank & otherwise\end{matrix} ,$$

in which x<y, 1st degree/rank<2nd degree/rank<3rd degree rank.

In an embodiment, the 1st degree/rank represents that portion(s) of wireless resources corresponding to the cell/region are to be assigned and/or utilized, via the proactive external wireless interface mitigation system, as normal-without being prevented from being assigned to a user equipment; the 2nd degree/rank represents that a group of PRBs of corresponding to the cell region are to be banned, via “notching”, from being scheduled to be utilized by the wireless device within the cell/region; and the 3rd degree rank represents that respective handovers of communication(s)—corresponding to a group of user equipment-from the wireless access point device to a neighboring wireless access point device of the wireless access point device are to be performed; or represents that respective idle mode redirections-corresponding to establishment of respective PDU sessions corresponding to the neighboring wireless access point device—are to be performed.

In embodiment(s) illustrated by FIG. 4, the 1st degree/rank represents a lowest determined degree/rank/level of external interference that has been determined, via the cell grid external interference detection component, to have impacted cell/regions 304, 306, 308, 310, and 312; the 2nd degree/rank represents an intermediate determined degree/rank/level of external interference that has been determined, via the cell grid external interference detection component, to have impacted cell/region 302; and the 3rd degree/rank represents a highest determined degree/rank/level of external interference that has been determined, via the cell grid external interference detection component, to have impacted cell/region 314.

In other embodiment(s), the cell grid external interference detection component can determine the percentage of PRBs of the cell/region that has been affected by the respective portions of the external interference by obtaining, via the data store, historical interference data representing percentages of respective PRBs of the cell/region of the group of cells/regions that have been affected by the respective portions of the external interference over respective defined periods. Further, based on the historical inference data, the cell grid external interference detection component can determine the percentage of PRBs of the cell/region that has been affected by the respective portions of the external interference.

In yet other embodiment(s), in response to determining that a location of a user equipment (not shown) corresponds to a cell/region of the wireless coverage area of the wireless access point device, the cell grid external interference detection component determines whether a defined degree/rank/level of external interference that has been associated with/assigned to the cell/region satisfies a defined condition representing that portion(s) of wireless resources corresponding to the cell/region are to be prevented from being assigned to the user equipment to minimize an effect of the external interference on the user equipment.

In an embodiment, in response to the defined degree/rank/level of external interference that has been associated with/assigned to the cell/region being determined, via the cell grid external interference detection component, to be equal to the 1st degree/rank—representing that that portion(s) of wireless resources corresponding to the cell/region are to be assigned and/or utilized, via the proactive external wireless interface mitigation system, as normal—without being prevented from being assigned to a user equipment—the cell grid external interference detection component does not prevent the portion(s) of the wireless resources from being assigned and/or utilized.

In embodiment(s), in response to the defined degree/rank/level of external interference that has been associated with/assigned to the cell/region being determined, via the cell grid external interference detection component, to be equal to the 2nd degree/rank—representing that a group of PRBs corresponding to the cell/region are to be banned from being scheduled to be utilized by the user equipment within the cell/region—the cell grid external interference detection component prevents the group of PRBs from being scheduled to be utilized by the user equipment within the cell/region.

In other embodiment(s), in response to the defined degree/rank/level of external interference that has been associated with/assigned to the cell/region being determined, via the cell grid external interference detection component, to be equal to the 3rd degree/rank—representing that respective handovers corresponding to user equipment or respective idle mode redirections corresponding to the user equipment are to be performed—the cell grid external interference detection component initiates at least one of the respective handovers or the respective idle mode redirections.

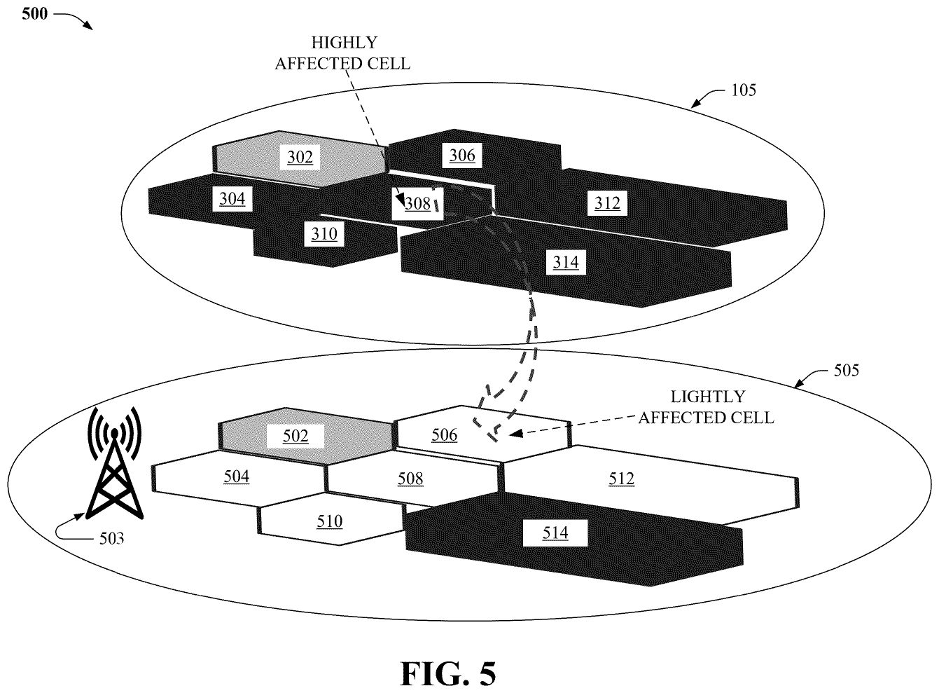

In yet other embodiment(s), and now referring to FIG. 5, the cell grid external interference detection component determines, for each user equipment of a group of user equipment (not shown) that is communicatively coupled to the wireless access point device, respective neighboring wireless access point devices (e.g., 503) corresponding to the wireless access point device.

Further, the cell grid external interference detection component determines respective degrees of external interference corresponding to the respective neighboring wireless access point devices. In response to a degree of the respective degrees of external interference corresponding to a neighboring wireless access point device of the neighboring wireless access point devices being determined, via the cell grid external interference detection component, to satisfy a defined condition representing that the neighboring wireless access point device is an acceptable handover/idle mode reselection candidate, the cell grid external interference detection component initiates a handover of the respective handovers of a wireless communication corresponding to the wireless access point device from the wireless access point device to the neighboring wireless access point device, or initiates an idle mode reselection corresponding to the neighboring wireless access point device.

In embodiment(s), the cell grid external interference detection component selects a neighboring wireless access point device of the respective neighboring wireless access point devices for initiation of the handover/idle mode reselection in response to the neighboring wireless access point device being determined, by the cell grid external interference detection component, to be associated with the best, or lowest, determined degree/rank as compared with remaining neighboring wireless access point devices of the respective neighboring wireless access point devices. In instances when the respective neighboring wireless access point devices are associated with determined degree/ranks that are greater than, e.g., worse than, determined degrees/ranks of external interference corresponding to the wireless access point device, or within a defined offset from the determined degrees/ranks of external interference corresponding to the wireless access point device, then no handover/idle mode reselection is initiated/performed.

In an embodiment illustrated by FIG. 5, in response to the defined degree/rank/level of external interference that has been associated with/assigned to cell/region 308 being determined, via the cell grid external interference detection component, to be equal to the 3rd degree/rank, the cell grid external interference detection component initiates the handover, or an idle mode redirection, via cell/region 506 of wireless access point device 503—in response to a determination that cell/region 506 is an acceptable handover/idle mode reselection candidate, e.g., representing that cell/region 506 has been assigned to the lowest determined degree/rank.

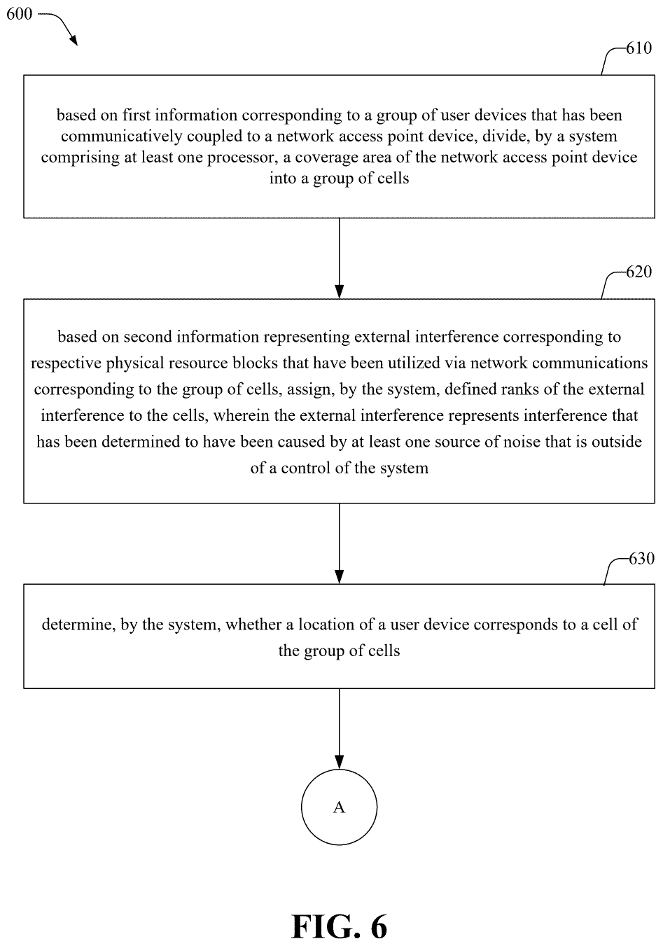

FIGS. 6-9 illustrate methodologies in accordance with the disclosed subject matter. For simplicity of explanation, the methodologies are depicted and described as a series of acts. It is to be understood and appreciated that various embodiments disclosed herein are not limited by the acts illustrated and/or by the order of acts. For example, acts can occur in various orders and/or concurrently, and with other acts not presented or described herein. Furthermore, not all illustrated acts may be required to implement the methodologies in accordance with the disclosed subject matter. In addition, those skilled in the art will understand and appreciate that the methodologies could alternatively be represented as a series of interrelated states via a state diagram or events. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

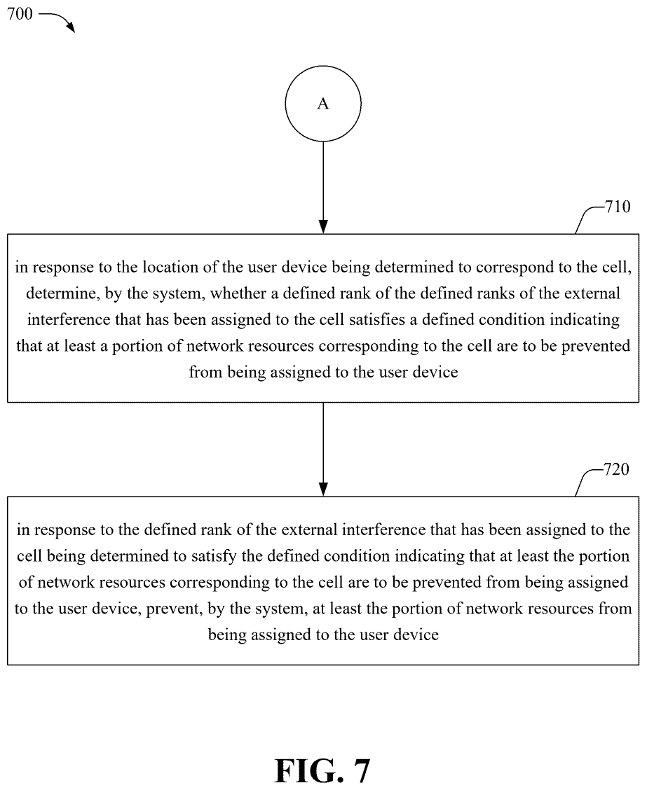

FIGS. 6-7 illustrate flow charts (600, 700) of a method associated with a system, e.g., a proactive external wireless interference mitigation system (110), in accordance with various example embodiments. At 610, based on first information corresponding to a group of user devices that has been communicatively coupled to a network access point device, the system divides a coverage area of the network access point device into a group of cells.

At 620, based on second information representing external interference corresponding to respective PRBs that have been utilized via network communications corresponding to the group of cells, the system assigns defined ranks of the external interference to the cells, wherein the external interference represents interference that has been determined to have been caused by at least one source of noise that is outside of a control of the system.

At 630, the system determines whether a location of a user device corresponds to a cell of the group of cells.

At 710, in response to the location of the user device being determined to correspond to the cell, the system determines whether a defined rank of the defined ranks of the external interference that has been assigned to the cell satisfies a defined condition indicating that at least a portion of network resources corresponding to the cell are to be prevented from being assigned to the user device.

At 720, in response to the defined rank of the external interference that has been assigned to the cell being determined to satisfy the defined condition indicating that at least the portion of network resources corresponding to the cell are to be prevented from being assigned to the user device, the system prevents at least the portion of network resources from being assigned to the user device.

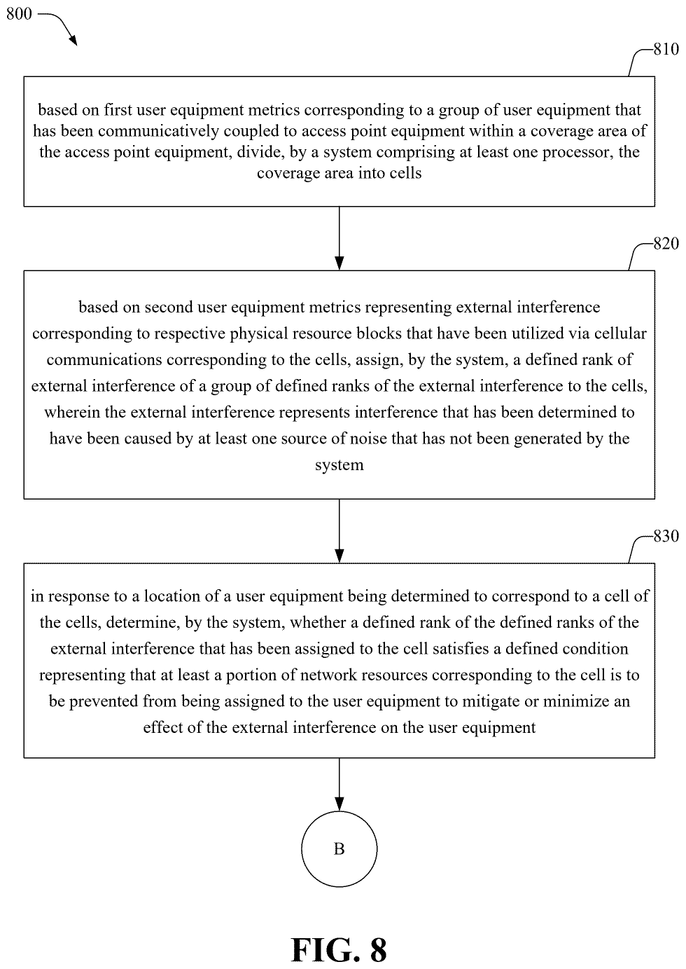

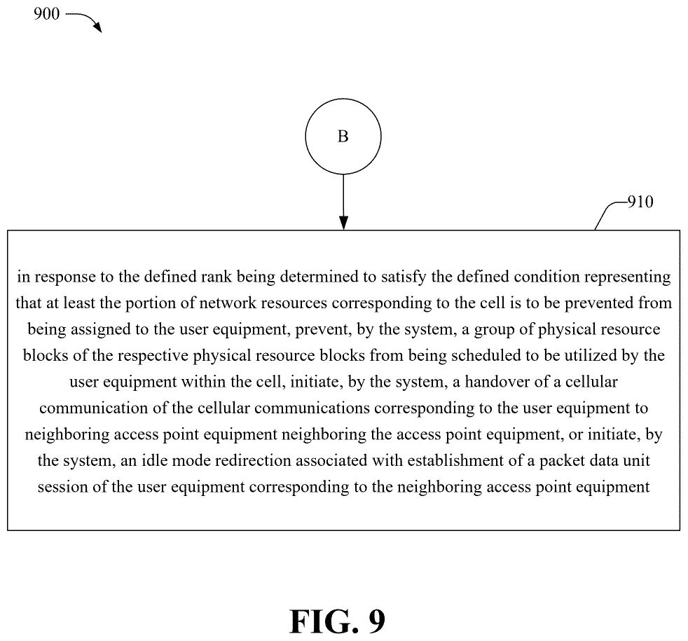

FIGS. 8-9 illustrate flow charts (800-900) of another method associated with a system, e.g., a proactive external wireless interference mitigation system (110), in accordance with various example embodiments. At 810, based on first user equipment metrics corresponding to a group of user equipment that has been communicatively coupled to access point equipment within a coverage area of the access point equipment, the system divides the coverage area into cells.

At 820, based on second user equipment metrics representing external interference corresponding to respective PRBs that have been utilized via cellular communications corresponding to the cells, the system assigns a defined rank of external interference of a group of defined ranks of the external interference to the cells, wherein the external interference represents interference that has been determined to have been caused by at least one source of noise that has not been generated by the system.

At 830, in response to a location of a user equipment being determined to correspond to a cell of the cells, the system determines whether a defined rank of the defined ranks of the external interference that has been assigned to the cell satisfies a defined condition representing that at least a portion of network resources corresponding to the cell is to be prevented from being assigned to the user equipment to mitigate or minimize an effect of the external interference on the user equipment.

At 910, in response to the defined rank being determined to satisfy the defined condition representing that at least the portion of network resources corresponding to the cell is to be prevented from being assigned to the user equipment, the system prevents a group of PRBs of the respective PRBs from being scheduled to be utilized by the user equipment within the cell, initiates a handover of a cellular communication of the cellular communications corresponding to the user equipment to neighboring access point equipment neighboring the access point equipment, or initiates an idle mode redirection associated with establishment of a packet data unit session of the user equipment corresponding to the neighboring access point equipment.

Reference throughout this specification to “one embodiment,” “an embodiment,” “another embodiment”, “yet another embodiment”, “embodiment(s)”, “other “embodiment(s)”, and “yet other embodiment(s)” means that a particular feature, structure, or characteristic described in connection with the embodiment is included in at least one embodiment. Thus, the appearances of the phrase “in one embodiment,” “in an embodiment,” “in another embodiment”, “in yet another embodiment”, “in embodiment(s)”, “in other embodiment(s)”, and “in yet other embodiment(s)” in various places throughout this specification are not necessarily all referring to the same embodiment. Furthermore, the particular features, structures, or characteristics may be combined in any suitable manner in one or more embodiments.

Furthermore, to the extent that the terms “includes,” “has,” “contains,” and other similar words are used in either the detailed description or the appended claims, such terms are intended to be inclusive-in a manner similar to the term “comprising” as an open transition word-without precluding any additional or other elements. Moreover, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

As utilized herein, terms “component”, “system”, and the like are intended to refer to a computer-related entity, hardware, software (e.g., in execution), middleware, and/or firmware. For example, a component can be a processor, a process running on a processor, an object, an executable, a program, a storage device, and/or a computer. By way of illustration, an application running on a server, client, etc. and the server, client, etc. can be a component. One or more components can reside within a process, and a component can be localized on one computer and/or distributed between two or more computers.

Further, components can execute from various computer readable media having various data structures stored thereon. The components can communicate via local and/or remote processes such as in accordance with a signal having one or more data packets (e.g., data from one component interacting with another component in a local system, distributed system, and/or across a network, e.g., the Internet, with other systems via the signal).

As another example, a component can be an apparatus with specific functionality provided by mechanical parts operated by electric or electronic circuitry; the electric or electronic circuitry can be operated by a software application or a firmware application executed by one or more processors; the one or more processors can be internal or external to the apparatus and can execute at least a part of the software or firmware application. In yet another example, a component can be an apparatus that provides specific functionality through electronic components without mechanical parts; the electronic components can comprise one or more processors therein to execute software and/or firmware that confer(s), at least in part, the functionality of the electronic components.

Aspects of systems, apparatus, and processes explained herein can constitute machine-executable instructions embodied within a machine, e.g., embodied in a computer readable medium (or media) associated with the machine. Such instructions, when executed by the machine, can cause the machine to perform the operations described. Additionally, the systems, processes, process blocks, etc. can be embodied within hardware, such as an application specific integrated circuit (ASIC) or the like. Moreover, the order in which some or all of the process blocks appear in each process should not be deemed limiting. Rather, it should be understood by a person of ordinary skill in the art having the benefit of the instant disclosure that some of the process blocks can be executed in a variety of orders not illustrated.

Furthermore, the word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art having the benefit of the instant disclosure.

The disclosed subject matter can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, computer-readable carrier, or computer-readable media. For example, computer-readable media can comprise, but are not limited to: random access memory (RAM); read only memory (ROM); electrically erasable programmable read only memory (EEPROM); flash memory or other memory technology (e.g., card, stick, key drive, thumb drive, smart card); solid state drive (SSD) or other solid-state storage technology; optical disk storage (e.g., compact disk (CD) read only memory (CD ROM), digital video/versatile disk (DVD), Blu-ray disc); cloud-based (e.g., Internet based) storage; magnetic storage (e.g., magnetic cassettes, magnetic tape, magnetic disk storage or other magnetic storage devices); a virtual device that emulates a storage device and/or any of the above computer-readable media; or other tangible and/or non-transitory media which can be used to store desired information. In this regard, the terms “tangible” or “non-transitory” herein as applied to storage, memory, or computer-readable media, are to be understood to exclude only propagating transitory signals per se as modifiers and do not relinquish rights to all standard storage, memory or computer-readable media that are not only propagating transitory signals per se.

As it is employed in the subject specification, the term “processing component” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions and/or processes described herein. Processors can exploit nano-scale architectures such as, but not limited to, molecular and quantum-dot based transistors, switches and gates, in order to optimize space usage or enhance performance of mobile devices. A processor may also be implemented as a combination of computing processing units.

In the subject specification, terms such as “data storage”, “data store”, “storage space”, “data storage device”, “storage medium”, “memory component”, and substantially any other information storage component relevant to operation and functionality of a system, component, and/or process, can refer to “memory components,” or entities embodied in a “memory,” or components comprising the memory. It will be appreciated that the memory components described herein can be either volatile memory or nonvolatile memory, or can comprise both volatile and nonvolatile memory.

By way of illustration, and not limitation, nonvolatile memory, for example, can be included in a memory component (250), non-volatile memory 1022 (see below), disk storage 1024 (see below), and/or memory storage 1046 (see below). Further, nonvolatile memory can be included in read only memory (ROM), programmable ROM (PROM), electrically programmable ROM (EPROM), electrically erasable ROM (EEPROM), or flash memory. Volatile memory (e.g., 1020) can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Additionally, the disclosed memory components of systems or methods herein are intended to comprise, without being limited to comprising, these and any other suitable types of memory.

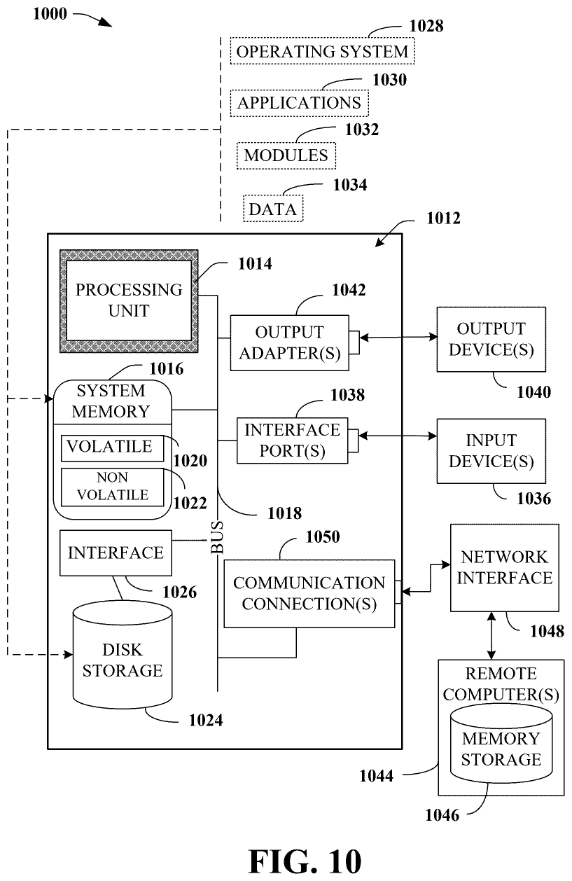

In order to provide a context for the various aspects of the disclosed subject matter, FIG. 10, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that various embodiments disclosed herein can be implemented in combination with other program modules. Generally, program modules comprise routines, programs, components, data structures, etc. that perform particular tasks and/or implement particular abstract data types.

Moreover, those skilled in the art will appreciate that the inventive systems can be practiced with other computer system configurations, comprising single-processor or multiprocessor computer systems, computing devices, mini-computing devices, mainframe computers, as well as personal computers, hand-held computing devices (e.g., PDA, phone, watch), microprocessor-based or programmable consumer or industrial electronics, and the like. The illustrated aspects can also be practiced in distributed computing environments where tasks are performed by remote processing devices that are linked through a communication network; however, some if not all aspects of the subject disclosure can be practiced on stand-alone computers. In a distributed computing environment, program modules can be located in both local and remote memory storage devices.

With reference to FIG. 10, a block diagram of a computing system 1000 operable to execute the disclosed systems and methods, e.g., via wireless communication environment (101), is illustrated, in accordance with an embodiment. Computer 1012 comprises a processing unit 1014, a system memory 1016, and a system bus 1018. System bus 1018 couples system components comprising, but not limited to, system memory 1016 to processing unit 1014. Processing unit 1014 can be any of various available processors. Dual microprocessors and other multiprocessor architectures also can be employed as processing unit 1014.

System bus 1018 can be any of several types of bus structure(s) comprising a memory bus or a memory controller, a peripheral bus or an external bus, and/or a local bus using any variety of available bus architectures comprising, but not limited to, industrial standard architecture (ISA), micro-channel architecture (MSA), extended ISA (EISA), intelligent drive electronics (IDE), VESA local bus (VLB), peripheral component interconnect (PCI), card bus, universal serial bus (USB), advanced graphics port (AGP), personal computer memory card international association bus (PCMCIA), Firewire (IEEE 1394), small computer systems interface (SCSI), and/or controller area network (CAN) bus used in vehicles.

System memory 1016 comprises volatile memory 1020 and nonvolatile memory 1022. A basic input/output system (BIOS), containing routines to transfer information between elements within computer 1012, such as during start-up, can be stored in nonvolatile memory 1022. By way of illustration, and not limitation, nonvolatile memory 1022 can comprise ROM, PROM, EPROM, EEPROM, or flash memory. Volatile memory 1020 comprises RAM, which acts as external cache memory. By way of illustration and not limitation, RAM is available in many forms such as SRAM, dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

Computer 1012 also comprises removable/non-removable, volatile/non-volatile computer storage media. FIG. 10 illustrates, for example, disk storage 1024. Disk storage 1024 comprises, but is not limited to, devices like a magnetic disk drive, floppy disk drive, tape drive, Jaz drive, Zip drive, LS-100 drive, flash memory card, or memory stick. In addition, disk storage 1024 can comprise storage media separately or in combination with other storage media comprising, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1024 to system bus 1018, a removable or non-removable interface is typically used, such as interface 1026.

It is to be appreciated that FIG. 10 describes software that acts as an intermediary between users, e.g., subscribers, and computer resources described in suitable operating environment 1000. Such software comprises an operating system 1028. Operating system 1028, which can be stored on disk storage 1024, acts to control and allocate resources of computer system 1012. System applications 1030 take advantage of the management of resources by operating system 1028 through program modules 1032 and program data 1034 stored either in system memory 1016 or on disk storage 1024. It is to be appreciated that the disclosed subject matter can be implemented with various operating systems or combinations of operating systems.

A user, e.g., subscriber, can enter commands or information into computer 1012 through input device(s) 1036. Input devices 1036 comprise, but are not limited to, a pointing device such as a mouse, trackball, stylus, touch pad, keyboard, microphone, joystick, game pad, satellite dish, scanner, TV tuner card, digital camera, digital video camera, web camera, cellular phone, user equipment, smartphone, and the like. These and other input devices connect to processing unit 1014 through system bus 1018 via interface port(s) 1038. Interface port(s) 1038 comprise, for example, a serial port, a parallel port, a game port, a universal serial bus (USB), a wireless based port, e.g., Wi-Fi, Bluetooth, etc. Output device(s) 1040 use some of the same type of ports as input device(s) 1036.

Thus, for example, a USB port can be used to provide input to computer 1012 and to output information from computer 1012 to an output device 1040. Output adapter 1042 is provided to illustrate that there are some output devices 1040, like display devices, light projection devices, monitors, speakers, and printers, among other output devices 1040, which use special adapters. Output adapters 1042 comprise, by way of illustration and not limitation, video and sound devices, cards, etc. that provide means of connection between output device 1040 and system bus 1018. It should be noted that other devices and/or systems of devices provide both input and output capabilities such as remote computer(s) 1044.

Computer 1012 can operate in a networked environment using logical connections to one or more remote computers, such as remote computer(s) 1044. Remote computer(s) 1044 can be a personal computer, a server, a router, a network PC, a workstation, a microprocessor-based appliance, a peer device, or other common network node and the like, and typically comprises many or all of the elements described relative to computer 1012.

For purposes of brevity, only a memory storage device 1046 is illustrated with remote computer(s) 1044. Remote computer(s) 1044 is logically connected to computer 1012 through a network interface 1048 and then physically and/or wirelessly connected via communication connection 1050. Network interface 1048 encompasses wire and/or wireless communication networks such as local-area networks (LAN) and wide-area networks (WAN). LAN technologies comprise fiber distributed data interface (FDDI), copper distributed data interface (CDDI), Ethernet, token ring and the like. WAN technologies comprise, but are not limited to, point-to-point links, circuit switching networks like integrated services digital networks (ISDN) and variations thereon, packet switching networks, and digital subscriber lines (DSL).

Communication connection(s) 1050 refer(s) to hardware/software employed to connect network interface 1048 to bus 1018. While communication connection 1050 is shown for illustrative clarity inside computer 1012, it can also be external to computer 1012. The hardware/software for connection to network interface 1048 can comprise, for example, internal and external technologies such as modems, comprising regular telephone grade modems, cable modems and DSL modems, wireless modems, ISDN adapters, and Ethernet cards.

The computer 1012 can operate in a networked environment using logical connections via wired and/or wireless communications to one or more remote computers, cellular based devices, user equipment, smartphones, or other computing devices, such as workstations, server computers, routers, personal computers, portable computers, microprocessor-based entertainment appliances, peer devices or other common network nodes, etc. The computer 1012 can connect to other devices/networks by way of antenna, port, network interface adaptor, wireless access point, modem, and/or the like.

The computer 1012 is operable to communicate with any wireless devices or entities operatively disposed in wireless communication, e.g., a printer, scanner, desktop and/or portable computer, portable data assistant, communications satellite, user equipment, cellular base device, smartphone, any piece of equipment or location associated with a wirelessly detectable tag (e.g., scanner, a kiosk, news stand, restroom), and telephone. This comprises at least Wi-Fi and Bluetooth wireless technologies. Thus, the communication can be a predefined structure as with a conventional network or simply an ad hoc communication between at least two devices.

Wi-Fi allows connection to the Internet from a desired location (e.g., a vehicle, couch at home, a bed in a hotel room, or a conference room at work, etc.) without wires. Wi-Fi is a wireless technology similar to that used in a cell phone that enables such devices, e.g., mobile phones, computers, etc., to send and receive data indoors and out, anywhere within the range of a base station. Wi-Fi networks use radio technologies called IEEE 802.11 (a, b, g, etc.) to provide secure, reliable, fast wireless connectivity. A Wi-Fi network can be used to connect communication devices (e.g., mobile phones, computers, etc.) to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

The above description of illustrated embodiments of the subject disclosure, comprising what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A system, comprising:
a processor; and
a memory that stores executable components that, when executed by the processor, facilitate performance of operations by the system, the operations comprising:
based on first wireless device metrics corresponding to a group of wireless devices that has been communicatively coupled to a wireless access point device, partitioning a wireless coverage area of the wireless access point device into respective regions;
based on second wireless device metrics representing external interference corresponding to respective physical resource blocks that have been utilized via wireless communications corresponding to the respective regions, associating defined degrees of the external interference to the respective regions; and
in response to determining that a location of a wireless device corresponds to a region of the respective regions, determining whether a defined degree of the defined degrees of the external interference that has been associated with the region satisfies a defined condition, wherein the defined condition represents that at least a portion of wireless resources corresponding to the region are to be prevented from being assigned to the wireless device to minimize an effect of the external interference on the wireless device.

2. The system of claim 1, wherein the first wireless device metrics comprise respective reference signal receive powers corresponding to the group of wireless devices and respective distributions of the wireless devices within the wireless coverage area.

3. The system of claim 1, wherein the group of wireless devices is a first group of wireless devices, wherein the second wireless device metrics comprise respective received signal strength indicators corresponding to a second group of wireless devices, and wherein the second wireless device metrics further represent locations of respective wireless devices of the second group of wireless devices within the wireless coverage area.

4. The system of claim 1, wherein the portion of wireless resources is a first portion of wireless resources, and wherein the associating of the defined degrees of the external interference to the respective regions comprises:
determining, for physical resource blocks of the respective physical resource blocks corresponding to a second portion of the wireless communications corresponding to the region, a percentage of the physical resource blocks that has been affected by respective portions of the external interference; and
based on the percentage of the physical resource blocks that has been determined to have been affected by the respective portions of the external interference, assigning a defined degree of the defined degrees of the external interference to the region.

5. The system of claim 4, wherein the determining of the percentage of the physical resource blocks that has been affected by the respective portions of the external interference comprises:
determining a received signal strength indicator corresponding to a physical resource block of the physical resource blocks; and
in response to the received signal strength indicator being determined to be greater than a defined maximum received signal strength indicator value, determining that the physical resource block has been affected by one or more portions of the respective portions of the external interference.

6. The system of claim 5, wherein the operations further comprise:
in response to the defined degree of the external interference being determined to satisfy the defined condition representing that at least the first portion of wireless resources corresponding to the region is to be prevented from being assigned to the wireless device, preventing, based on the defined degree of the external interference, at least the first portion of wireless resources from being assigned to the wireless device to mitigate or minimize the effect of the external interference on the wireless device.

7. The system of claim 6, wherein the preventing comprises:
in response to the defined degree of the external interference being determined to represent that a group of physical resource blocks of the respective physicals resource blocks corresponding to the region are to be banned from being scheduled to be utilized by the wireless device within the region, preventing the group of physical resource blocks from being scheduled to be utilized by the wireless device within the region.

8. The system of claim 6, wherein the group of wireless devices is a first group of wireless devices, wherein a second group of wireless devices comprises the wireless device, and wherein the preventing comprises:
in response to the defined degree of the external interference being determined to represent that at least one of respective handovers corresponding to wireless devices of the second group of wireless devices or respective idle mode redirections corresponding to the wireless devices are to be performed, initiating at least one of the respective handovers or the respective idle mode redirections.

9. The system of claim 8, wherein the defined condition is a first defined condition, and wherein the initiating of the respective handovers comprises:
determining, for each wireless device of the second group of wireless devices, respective neighboring wireless access point devices corresponding to the access point device;
determining respective degrees of external interference corresponding to the respective neighboring wireless access point devices; and
in response to a degree of the respective degrees of external interference corresponding to a neighboring wireless access point device of the neighboring wireless access point devices being determined to satisfy a second defined condition representing that the neighboring wireless access point device is an acceptable handover candidate, initiating a handover of the respective handovers of a wireless communication corresponding to the wireless access point device from the wireless access point device to the neighboring wireless access point device.

10. The system of claim 8, wherein the defined condition is a first defined condition, and wherein the group of wireless devices is a first group of wireless devices, wherein a second group of wireless devices comprises the wireless device, and wherein the initiating of the respective idle mode redirections comprises:
determining, for each wireless device of the second group of wireless devices, respective neighboring wireless access point devices corresponding to the access point device;
determining respective degrees of external interference corresponding to the respective neighboring wireless access point devices; and
in response to a degree of external interference of the respective degrees of external interference corresponding to a neighboring wireless access point device of the neighboring wireless access point devices being determined to satisfy a second defined condition representing that the neighboring wireless access point device is an acceptable idle mode redirection candidate, initiating, for the wireless device, an idle mode redirection associated with establishment of a packet data unit session corresponding to the neighboring wireless access point device.

11. A method, comprising:
based on first information corresponding to a group of user devices that has been communicatively coupled to a network access point device, dividing, by a system comprising at least one processor, a coverage area of the network access point device into a group of cells;
based on second information representing external interference corresponding to respective physical resource blocks that have been utilized via network communications corresponding to the group of cells, assigning, by the system, defined ranks of the external interference to the cells, wherein the external interference represents interference that has been determined to have been caused by at least one source of noise that is outside of a control of the system;
determining, by the system, whether a location of a user device corresponds to a cell of the group of cells; and
in response to the location of the user device being determined to correspond to the cell, determining, by the system, whether a defined rank of the defined ranks of the external interference that has been assigned to the cell satisfies a defined condition indicating that at least a portion of network resources corresponding to the cell are to be prevented from being assigned to the user device.

12. The method of claim 11, wherein the dividing of the coverage area into the group of cells comprises:
dividing, via a density-based spatial clustering of applications with noise algorithm, the coverage area into the group of cells.

13. The method of claim 11, wherein the assigning of the defined ranks of the external interference to the cells comprises:
based on the second group of defined performance indicators, assigning a rank of a group of three ranks to respective cells of the group of cells.

14. The method of claim 11, further comprising:
in response to the defined rank of the external interference that has been assigned to the cell being determined to satisfy the defined condition indicating that at least the portion of network resources corresponding to the cell are to be prevented from being assigned to the user device, preventing, by the system, at least the portion of network resources from being assigned to the user device.

15. The method of claim 14, wherein the preventing comprises:
in response to the defined rank of the external interference being determined to represent that a group of physical resource blocks of the respective physicals resource blocks corresponding to the cell are to be banned from being scheduled to be utilized by the user device within the cell, preventing the group of physical resource blocks from being scheduled to be utilized by the user device within the cell; and
in response to the defined rank of the external interference being determined to represent that at least one of respective handovers corresponding to user devices or respective idle mode redirections corresponding to the user devices are to be performed, initiating at least one of the respective handovers or the respective idle mode redirections.

16. The method of claim 11, wherein the assigning of the defined ranks of the external interference comprises:
determining, by the system, a percentage of physical resource blocks of the respective physical resource blocks of the cell that has been affected by respective portions of the external interference; and
based on the percentage of physical resource blocks that has been determined to have been affected by the respective portions of the external interference, assigning, by the system, a defined rank of the defined ranks of the external interference to the cell.

17. The method of claim 16, wherein the determining of the percentage of physical resource blocks that has been affected by the respective portions of the external interference comprises:
in response to a received signal strength indicator corresponding to a physical resource block of the physical resource blocks being determined to be greater than a defined received signal strength indicator threshold value, determining, by the system, that the physical resource block has been affected by one or more portions of the respective portions of the external interference.

18. The method of claim 16, wherein the determining of the percentage of physical resource blocks that has been affected by the respective portions of the external interference comprises:
obtaining, via a data store, historical interference data representing percentages of the respective physical resource blocks of the cell that have been affected by the respective portions of the external interference over respective defined periods; and
based on the historical inference data, determining the percentage of physical resource blocks of the respective physical resource blocks of the cell that has been affected by respective portions of the external interference.

19. A non-transitory machine-readable medium, comprising executable instructions that, when executed by a processor, facilitate performance of operations, comprising:
based on first user equipment metrics corresponding to a group of user equipment that has been communicatively coupled to access point equipment within a coverage area of the access point equipment, dividing the coverage area into cells;
based on second user equipment metrics representing external interference corresponding to respective physical resource blocks that have been utilized via cellular communications corresponding to the cells, assigning a defined rank of external interference of a group of defined ranks of the external interference to the cells, wherein the external interference represents interference that has been determined to have been caused by at least one source of noise that has not been generated by the system; and
in response to a location of a user equipment being determined to correspond to a cell of the cells, determining whether a defined rank of the defined ranks of the external interference that has been assigned to the cell satisfies a defined condition representing that at least a portion of network resources corresponding to the cell is to be prevented from being assigned to the user equipment to mitigate or minimize an effect of the external interference on the user equipment.

20. The non-transitory machine-readable medium of claim 19, wherein the operations further comprise:
in response to the defined rank being determined to satisfy the defined condition representing that at least the portion of network resources corresponding to the cell is to be prevented from being assigned to the user equipment,
preventing a group of physical resource blocks of the respective physical resource blocks from being scheduled to be utilized by the user equipment within the cell,
initiating a handover of a cellular communication of the cellular communications corresponding to the user equipment to neighboring access point equipment neighboring the access point equipment, or
initiating an idle mode redirection associated with establishment of a packet data unit session of the user equipment corresponding to the neighboring access point equipment.
